(19) United States
(12) Patent Application Publication
(10) Pub. No.: US 2011/0033795 A1
(43) Pub. Date: Feb. 10, 2011

(54) TONER, PRODUCTION METHOD OF TONER, DEVELOPER AND IMAGE FORMATION METHOD

(75) Inventors: Mikio Kouyama, Tokyo (JP); Kenji Hayashi, Tokyo (JP); Hiroaki OBata, Tokyo (JP); Noriyuki Kimpara, Tokyo (JP); Hiroshi Nagasawa, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/919,714

(22) PCT Filed: Jul. 22, 2009
(86) PCT No.: PCT/JP2009/063090

§ 371 Date: Aug. 26, 2010

(30) Foreign Application Priority Data
Jul. 23, 2008 (JP) 2008-189776

(51) Int. Cl. G03G 9/087; G03G 9/09; G03G 13/20

(52) U.S. Cl. 430/109.4; 430/137.14; 430/124.1

(57) ABSTRACT

A toner which can be improved in both low-temperature fixability and offset resistance is disclosed, comprising a colorant and a binder resin containing a polyester ionomer resin which has been reacted with a polyvalent isocyanate compound.

### TECHNICAL FIELD

The present invention relates to a toner containing at least a colorant and a binder resin, a production method of the toner, a developer containing the toner and an image formation method.

### TECHNICAL BACKGROUND

Generally, in an electrophotographic image forming method, printed materials are prepared via the steps set forth below. First, a photoreceptor is exposed to light to form a latent image on the photoreceptor and then, a toner is supplied onto the photoreceptor to develop the latent image to form a toner image. Subsequently, the toner image on the photoreceptor is transferred to a transfer material such as paper and the transferred image is subjected to heating or pressure to fix the toner image, whereby a printed material is prepared. Further, after transfer of the toner image, a toner remained on the photoreceptor is removed by a cleaning device, rendering it feasible to perform subsequent image formation.

Recently, full-color print making by using plural kinds of color toners has been conducted and to perform efficient preparation of full-color prints, however, speedup image formation has been sought. To achieve high-speed print making, toners have been required to achieve faster electric-charging capability and rapid fixability. Further, from the view-point of enhancement of fixability, reduction of consumed energy in image formation is required from the consciousness of the global environment. Accordingly, there has been noted development of a toner corresponding to a technique of so-called low-temperature fixing.

A toner image formed on transfer paper is required to be melted in a state exhibiting a certain extent of viscosity under a prescribed condition and strong adhesion to the transfer paper. In cases when only the toner on the image surface is melted and the toner on the transfer paper side is only softened while the toner image passes through a fixing device, the toner which has been transferred to a transfer paper does not completely melt and does not achieve sufficient adhesion onto a transfer paper. Consequently, a toner image on the transfer paper adheres to a heating roller via a melted toner, causing image staining, so-called cold offset. Alternatively when a toner melts to such an extent that the viscosity of the toner is greatly reduced, a melted toner image ruptures and is transferred onto both the transfer paper and the fixing roller, causing image staining, so-called hot offset.

Thus, to achieve high-speed print making and low-temperature fixability, a toner is required perform melting in a state exhibiting a certain extent of viscosity and strong adhesion onto transfer paper, so that offset resistance performance to inhibit occurrence of image staining due to melting troubles of a toner is also desired. Accordingly, a physical property of a binder resin with respect to heat has become one of the important factors affecting offset resistance. Further, such a physical property of a binder resin with respect to heat is one of important factors to achieve low temperature fixing.

Thus, a toner capable of achieving both low-temperature fixability and offset resistance has been desired and there has been studied designing a toner to resolve this problem with noting a binder resin constituting such a toner. Examples thereof include control of a low molecular weight component and a high molecular weight component in the binder resin and introduction of a crosslinking structure. Specifically, there was disclosed a technique of a toner employing a binder resin obtained by use of a styrene-acrylic acid copolymeric resin having a broad molecular weight distribution without a high molecular weight region and a metal compound in which a crosslinking structure was formed between carboxyl groups of the polymer and the metal compound (as described in, for example, Patent document 1). This technique intended to achieve enhanced offset resistance substantially by an increased molecular weight of a binder resin through formation of a crosslinking structure, however, an increased amount of the metal compound caused a catalytic action, resulting in gelation of the resin and leading to inhibition of fixing.

There was also studied designation of a toner corresponding to low temperature-fixing capability by controlling the acid value, the hydroxyl group value and the molecular weight distribution of a polyester resin, and components insoluble in tetrahydrofuran (as described in, for example, Patent document 2). However, it was proved that this technique resulted in lowering of the melting temperature, leading to reduced offset resistance.

Thus, noting a binder resin as a toner constituent, studies of a toner capable of achieving both low temperature-fixing capability and offset resistance have been made but further investigation is required.

### PRIOR ART DOCUMENT

### PATENT DOCUMENT

Patent document 1: JP 61-110156A

Patent document 2: JP 09-204071A

### SUMMARY OF THE INVENTION

### Problem to be Solved in the Invention

In view of the foregoing problems, it is an object of the present invention to provide a toner which can achieve improvements of both low-temperature fixability and offset resistance through modification of a binder resin as a constituent of a toner. Specifically, it is an object to provide a toner capable of achieving superior fixing without causing image staining such as cold offset or hot offset and allowing a toner image to be sufficiently adhered to transfer paper even at a relatively low temperature.

### Means for Solving the Problems

Study of a toner which achieves enhancement of both low temperature-fixing capability and offset resistance was undertaken by the inventors of this application. Namely, there was studied designation of a toner capable of maintaining a certain extent of melt viscosity without rupture of the melted toner, while achieving a relatively low melt viscosity and a relatively high fluidity at which fixing of toner images is performed at a lower temperature than conventional fixing, in the course of which a binder resin constituting a toner was noticed.

As a result, it was found that the foregoing problems were dissolved by use of a binder resin containing a polyester ionomer resin and further by use of a binder resin containing a polyester ionomer resin modified with a polyvalent isocyanate compound.

1. A toner comprising a colorant and a binder resin, wherein the binder resin comprises a polyester ionomer resin which has been reacted with a polyvalent isocyanate compound.

2. A production method of a toner, the method comprising allowing at least polyester ionomer resin particles and colorant particles to coagulate and fuse to produce particles.

3. The production method as described in 2, wherein the method comprises allowing the polyester ionomer resin particles which have been reacted with a polyvalent isocyanate compound and the colorant particles to coagulate and fuse to produce particles.

4. The production method as described in 2, wherein the method comprises reacting the particles produced by allowing the polyester ionomer resin particles and the colorant particles to coagulate and fuse to react with a polyvalent isocyanate compound.

5. A developer comprising a toner, as described in 1.

6. An image forming method comprising the steps of

a latent image forming step of forming a latent image on the surface of an electrophotographic photoreceptor,

a developing step of developing the latent image formed on the photoreceptor surface with a developer described in the foregoing 5 and carried by a developer carrier to form a toner image,

a transfer step of transferring the toner image onto the surface of a transfer material, and

a fixing step of heat-fixing the toner image transferred onto the transfer material surface.

### Effect of the Invention

In the present invention, allowing a polyester ionomer resin which has been reacted with a polyvalent isocyanate compound to be contained in a binder resin forming a toner, rendering it feasible to provide a toner capable of performing enhanced compatibility of low-temperature fixability and offset resistance. Namely, the toner related to the invention made it possible to melt a toner image at a low temperature relative to a conventional fixing temperature and to achieve enhanced fluidity of the melted toner image without causing rupture of the image.

Thus, the toner related to the present invention does not lead to a melt viscosity causing cold offset or hot offset even when fixing at a lower temperature relative to a conventional fixing temperature, rendering it feasible to achieve enhancements of low temperature-fixing capability and offset resistance. Namely, melted toner images are not adhered to a fixing device, rendering it possible to achieve stable fixation without causing image staining.

Further, it becomes feasible to stick a toner image strongly onto transfer paper at a lower temperature than a conventional fixing temperature.

### BRIEF DESCRIPTION OF THE DRAWINGS

FIG. 1 illustrates an example of a black-and-white type image forming apparatus in which the toner related to the invention is usable.

FIG. 2 illustrates an example of a tandem type color image forming apparatus in which the toner related to the invention is usable.

FIG. 3 illustrates another example of a color image forming apparatus in which the toner related to the invention is usable.

### PREFERRED EMBODIMENTS OF THE INVENTION

The toner related to the invention relates to a so-called low temperature-fixable toner capable of melting a toner image at a low temperature relative to a conventional fixing temperature and fixing it onto transfer paper, and comprises a binder resin containing a polyester ionomer resin which has been reacted with a polyvalent isocyanate compound.

The inventors of this application noticed a viscoelastic behavior characteristic of a polyester resin and found that an improvement of this characteristic resolved the problem of the invention.

A polyester resin was capable of being fixed at a low temperature but tended to result in markedly reduced viscosity. Accordingly, the inventors presumed that the use of a polyester ionomer resin using a metal ion realized low temperature fixing without causing a lowering of viscosity and extensive study has achieved the present invention.

Herein, the polyester ionomer resin refers to a resin having a structure of polyester molecules forming an aggregate through the cohesive force of metal ions. It is presumed that the toner related to the invention easily melts at a lower temperature relative to a conventional fixing temperature and achieves enhanced fluidity through a characteristic such that intermolecular cross-linking formed through metal ions easily becomes loose at a relatively low temperature and exhibits fluidity. Further, it is presumed that a melted toner does not cause a marked lowering of viscosity and can maintain a certain extent of melt viscosity.

Thus, in the invention, it was found that the use of a polyester ionomer resin which has been reacted with a polyvalent isocyanate compound achieved enhancement of both low temperature-fixing capability and offset resistance. Namely, there was found a toner which exhibited a preferable melting property without causing a marked reduction of viscosity, while achieving enhanced fluidity, even when heating a toner image at a fixing temperature lower than a conventional fixing temperature.

In the following, the present invention will be described further in detail.

The toner related to the invention is formed by allowing at least polyester ionomer resin particles and colorant particles to coagulate and fuse. In the invention, a polyester ionomer resin is prepared by a process of subjecting the resin to a modification treatment with a polyvalent isocyanate compound. Modification with a polyvalent isocyanate compound can obtain a polyester resin with an extended molecular chain structure.

A polyester constituting a polyester ionomer resin used in the invention can be obtained by a polycondensation reaction of a polycarboxylic acid and a polyhydric alcohol. Specifically, polycondensation of a di-carboxylic acid and a diol is a typical one but, for example, some of carboxylic acids or some of alcohols may be one having three or more carboxylic acid groups or one having three or more alcoholic groups. In that case, addition of three or more carboxylic acid groups or three or more alcoholic groups forms a branched polyester or a cross-linked polyester. Generally, a polyester used for a polyester ionomer resin preferably employs a straight chain polyester.

Further, to obtain a polyester ionomer, addition of a compound capable of forming a two- or higher valent metal ion, such as a magnesium ion, calcium ion or zinc ion can form a metal-crosslinking structure between the metal ion and a polyester molecule.

A method of forming polyester resin particles is generally conducted in the manner that a polyester resin is dissolved in a water-immiscible solvent and then dispersed in an aqueous phase. There is also a method in which a polyester resin is added to an aqueous phase heated at a temperature higher than the melting point of the resin to be finely dispersed and thereby, the resin can be finely dispersed without using an organic solvent. In that case, when a compound capable of giving rise to a polyvalent metal ion, such as calcium hydroxide or magnesium hydroxide is added to the aqueous phase, ionomer formation can be performed in the presence of such a polyvalent metal ion, while being finely dispersed. Further, addition of a surfactant such as an anionic surfactant to the aqueous phase enables control of the particle size of polyester resin particles, leading to enhanced dispersibility.

A commercially available polyester ionomer resin is also usable in the invention. Examples of such a commercially available polyester ionomer resin include Finetex ES-675, ibid ES-2200, ibid ES-850 and ibid ES-801, produced by Dainippon Ink Kagaku kogyo Co., Ltd.

In the invention is used a polyester ionomer resin modified with a polyvalent isocyanate compound. The polyvalent isocyanate compound refers to a compound containing two or more isocyanate groups (—NCO) in the molecule structure, and including, for example, diisocyanates compounds, such as aliphatic diisocyanates, alicyclic diisocyanates, aromatic diisocyanates, naphthalene diisocyanates, biphenyl diisocyanates, di- or tri-phenylmethane (or ethane) diisocyanates, and the like; triisocyanate compounds having three isocyanate groups in the foregoing compounds, and polyisocyanates. A modification treatment is carried out by using these compounds, singly or in combination.

A polyester constituting a polyester ionomer resin used in the invention preferably has a weight average molecular weight falling within the range of 1,000 to 20,000, and more preferably 1,500 to 13,000. The glass transition temperature is preferably in the range of 20 to 70° C., and more preferably 30 to 60° C. The average particle size of polyester ionomer resin particles is preferably in the range of 20 to 500 nm, and more preferably 30 to 350 nm.

In the invention, a polyester ionomer resin is preferably used, as a binder resin, in combination with other resin materials, typified by a vinyl resin. When forming a binder resin in combination with a vinyl resin, for example, the content of a polyester ionomer resin is preferably not less than 3% by mass and not more than 50% by mass, and more preferably not less than 5% by mass and not more than 45% by mass.

In the invention, resin particles containing a polyester ionomer resin, as described above and colorant particles are allowed to coagulate and fuse to form colored particles (which are parent particles prior to addition of external additives), but wax particles may be used in combination with them to form colored particles.

There may optionally be formed a core/shell structure and, for example, it is preferred to form a shell layer on the surface of particles formed through coagulation and fusion. Resin particles to form a shell layer preferably are vinyl resin particles, and more preferably those having a higher glass transition temperature and softening point than the core particles. It is also preferred to use a resin having a different solubility parameter (SP value) from the vinyl resin forming core particles.

Next, there will be described a production method of a toner related to the invention.

The toner related to the invention are comprised of particles containing at least a binder resin and a colorant, as described above (i.e., colored particles, which are referred to parent particles prior to addition of external additives). Colored particles constituting the toner related to the invention, which are not specifically restricted, can be produced by the conventional toner production method. Namely, a toner can be produced by application of a toner production method by a grinding process of producing a toner via kneading, grinding and classifying steps and a toner production method by a polymerization process of polymerizing a polymerizable monomer with controlling shape or size to form particles.

Of these, a so-called polymerization toner produced by a polymerization process can easily attain a uniform distribution of particle size or shape and a sharp distribution of electrostatic charge. A polymerization toner is produced via a step of forming resin particles such as a polyester ionomer resin through polymerization reaction such as suspension polymerization or emulsion polymerization. Of the foregoing methods is specifically preferred production by a coalescence process of allowing resin particles prepared through a polymerization reaction to be coagulated and fused.

There will now be described a preparation method of a toner by a process of emulsion association, as a toner preparation method relating to the invention. Preparation of a toner by a process of emulsion association is conducted through the following steps:

(1) Preparation of resin particle dispersion

(2) Preparation of colorant particle dispersion

(3) Coagulation/fusion of resin particle

(4) Ripening

(5) Cooling

(6) Washing

(7) Drying

(8) External additive treatment

In the following, there will be detailed the respective steps.

### (1) Preparation of Resin Particle Dispersion:

In this step, a polymerizable monomer to form resin particles is fed to an aqueous medium to perform polymerization, and thereby forming resin particles with a size of approximately 100 nm. There may be formed resin particles containing a wax. In that case, a wax is dissolved or dispersed in a polymerizable monomer, which is polymerized in an aqueous medium to form wax-containing resin particles.

In this step, polyester ionomer resin particles can be prepared in addition to a vinyl resin particle dispersion. Such polyester ionomer resin particles can be prepared, for example by a method of preparation of polyester ionomer resin particle dispersion 1 in Examples, as described later.

In the invention, the thus prepared particulate polyester ionomer resin is further allowed to react with a polyvalent isocyanate compound to prepare a particulate polyester ionomer resin having a longer molecular chain length than that of the original particulate polyester ionomer resin. Such polyester ionomer resin particles prepared through the step of reaction with a polyvalent isocyanate compound to extend a molecular chain length can be prepared, for example, by the method of “Polyester ionomer resin particle dispersion 2” in Example, as described later.

### (2) Preparation of Colorant Particle Dispersion:

In this step, a colorant is dispersed in an aqueous medium to prepare a colorant particle dispersion in accordance with the procedure, as described earlier. Specifically, in the present invention, a colorant particle dispersion is prepared by using a particulate colorant having a number average primary particle size of 30 to 200 nm. When preparing a toner by using such a colorant particle dispersion, the number average particle size of a colorant within toner particles is 1.1 to 2.5 times the number average primary particle size.

### (3) Coagulation/Fusion of Resin Particle:

In this step, resin particles and colorant particles are coagulated to form particles and the particles thus formed by coagulation are fused, whereby colored particles (that is, parent particles prior to an external additive treatment) are prepared, corresponding to so-called “step of coagulating resin particles”. In the invention, at least polyester ionomer resin particles and colorant particles are coagulated and fused to form colored particles. In this step, polyester ionomer resin particles having reacted with a polyvalent isocyanate compound and exhibiting a longer molecular chain length than the original polyester ionomer resin particles and colorant particles may be coagulated and fused.

In this step, a coagulant of an alkali metal salt or an alkaline earth metal salt such as magnesium chloride is added to an aqueous medium containing resin particles such as polyester ionomer resin particles and colorant particles to coagulate these particles. Subsequently, the aqueous medium is heated at a temperature higher than the glass transition temperature of the resin particles and then the melting peak temperature of the mixture to allow coagulation to proceed and to allow coagulated resin particles to fuse and coalesce. When allowing coagulation to proceed and reaching the targeted particle size, a salt such as sodium chloride or the like is added to stop coagulation, whereby the targeted colored particles are formed. In the invention, colored particles which are prepared through coagulation and fusion of polyester ionomer resin particles and colorant particles may be reacted with a polyvalent isocyanate compound to extend the molecular chain length of the polyester ionomer resin. A method of preparing a toner via a step of adding a polyvalent isocyanate compound after formation of colored particles include, for example, a method for “Colored particle 11” described later in Examples.

In preparation of a toner of core/shell structure, first, resin particles for a core and colorant particles are allowed to coagulate and fuse to form core particles and subsequently, resin particles to form a shell are fed thereto to be allowed to coagulate and fuse onto the core particle surface. Thus, the coagulation/fusion step is conducted two-stepwise to prepare colored particles of core/shell structure.

### (4) Ripening:

Subsequent to the foregoing coagulation/fusion step, the reaction system is subjected to a heat treatment to ripen colored particles until the colored particles reach the targeted average circularity. This ripening step is also called the shape controlling step. In the invention, the shape of colored particles can be controlled by heating colored particles formed by the foregoing coagulation/fusion step at a temperature higher than the glass transition temperature of a polyester ionomer resin contained in the colored particles.

### (5) Cooling:

In this cooling step, a dispersion of colored particles is subjected to a cooling treatment (rapid cooling treatment). A cooling treatment is conducted at a cooling rate of 1 to 20° C./min. A cooling treatment is not specifically limited and examples thereof include a method in which a cooling medium is introduced from the outside of a reactor and a method in which a cooling water is fed directly to the reaction system.

### (6) Washing:

This washing step comprises a solid/liquid separation step of separating colored particles from a colored particle dispersion which was cooled to a prescribed temperature in the foregoing step and a subsequent washing step to remove any attached surfactant, coagulant or the like from the wetted surface of separated color particles.

Washing is conducted with water until the electric conductivity of the filtrate reaches a level of 10 μS/cm. Examples of methods for a solid/liquid separation include a centrifugal separation method, a reduced-pressure filtration method using a Nutsche funnel and a filtration method using a filter press.

### (7) Drying:

In this drying step, washed colored-particles are dried to obtain dryed colored-particles. Examples of a dryer usable in this step include a spray dryer, a vacuum freeze-dryer and a reduced-pressure dryer. However, it is preferred to use a standing plate dryer, a mobile plate dryer, a fluidized-bed dryer, a rotary dryer or a stirring dryer.

The moisture content of dried colored-particles is preferably not more than 5% by mass, and more preferably not more than 2% by mass. In cases when dryed colored-particles are aggregated by a weak attractive force between particles to form an aggregate, such an aggregate may be subjected to a disintegration treatment. There are usable mechanical disintegrators such as a jet mill, a HENSCHEL MIXER, a coffee mill or a food processor.

### (8) External Additive Treatment:

In this external additive treatment step, external additives or a lubricant is added to dried colored-particles to prepare toner particles usable for image formation. Colored particles which were subjected to the drying step may be used as toner particles, but addition of external additives can enhance the electrostatic-charging property, fluidity and cleaning property. External additives usable in the present invention include, for example, organic or inorganic particles and aliphatic metal salts. An external additive is added preferably in an amount of 0.1 to 10.0% by mass, and more preferably 0.5 to 4.0% by mass. A variety of additives may be combined. Examples of a mixing device, used to add external additives include a tubular mixer, a HENSCHEL MIXER, a Nauta Mixer, a V-type mixer and a coffee mill.

The toner related to the invention in which a binder resin contains polyester ionomer resin particles can be produced through the foregoing steps.

There will be further described the toner related to the invention. As described earlier, the toner related to the invention comprises a binder resin containing a polyester ionomer resin, a colorant, a wax and the like, and its volume-based median diameter (D50v) is preferably from 3 to 20 μm, and more preferably from 5 to 12 μm.

The volume-based median diameter (D50v) of a toner can be measured and calculated by using Multisizer 3 (made by Beckman Coulter Co.) connected to a computer system for data processing.

A toner in an amount of 0.02 g is treated with a 20 ml surfactant solution (in which a neutral detergent containing a surfactant component is diluted 10 times with pure water) and then subjected to ultrasonic dispersion for 1 min. to prepare a toner dispersion. The toner dispersion is introduced by a pipette into a beaker containing ISOTON II (produced by Beckman Coulter Co.), placed in a sample stand until reaching a measured concentration of 5-10% and the analyzer count is set to 2500 particles. The aperture diameter of Multisizer 3 is 50 μm.

The toner of the invention is directed to a toner capable of achieving enhanced low-temperature fixability and improved offset resistance, in which a binder resin constituting a toner preferably exhibits a glass transition temperature of 60 to 70° C. The glass transition temperature of a binder resin can be determined by using, for example, a DSC-7 differential scanning calorimeter (produced by Perkin Elmer Corp.) or a TAC7/DX thermal analysis controller (produced by Perkin Elmer Corp.). The measurement is conducted as follows. A toner of 4.5-5.0 mg is precisely weighed to two places of decimals, sealed into an aluminum pan (KIT NO. 0219-0041) and set into a DSC-7 sample holder. An empty aluminum pan is used as a reference. Temperature is controlled through heating-cooling-heating at a temperature-raising rate of 10° C./min and a temperature-lowering rate of 10° C./min in the range of 0 to 200° C.

An extension line from the base-line prior to the initial rise of the first endothermic peak and a tangent line exhibiting the maximum slope between the initial rise and the peak are drawn and the intersection of both lines is defined as the glass transition point.

There will now be described a resin material, a colorant, and wax used in combination with a binder resin constituting the toner related to the present invention, with reference to specific examples.

A binder resin used for the toner of the invention is one containing a polyester ionomer resin, which may be used in combination with other resins, such as a vinyl resin, as described earlier. A resin material which is used, as a constituent of the binder resin, in combination with a polyester ionomer resin is not specifically limited but, for example, a commonly known vinyl resin is typical one.

Specific examples of a polymerizable vinyl monomer are described below. Styrene monomers used to form a resin by using a polymer of the formula (1) include styrene and its derivatives, as shown below. Further, (meth)acryl monomers include not only an acrylic acid monomer and a methacrylic acid monomer but also acrylic acid ester derivatives and methacrylic acid ester derivatives, as shown below:

### (1) Styrene and Styrene Derivative:

styrene, o-methylstyrene, m-methylstyrene, p-methylstyrene, □-m methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene;

### (2) Methacryl Acid Ester Derivative:

methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, dimethylaminoethyl methacrylate;

### (3) Acrylic Acid Ester Derivative:

methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, phenyl acrylate;

### (4) Olefins:

ethylene, propylene, isopbutylene;

### (5) Vinyl Esters:

vinyl propionate, vinyl acetate, vinyl benzoate;

### (6) Vinyl Ethers:

vinyl methyl ether, vinyl ethyl ether,

### (7) Vinyl Ketones:

vinyl methyl ketone, vinyl ethyl ketone, vinyl hexyl ketone;

### (8) N-vinyl Compounds:

N-vinylcarbazole, N-vinylindole, N-vinylpyrrolidone;

### (9) Others:

vinyl compounds such as vinylnaphthalene, vinylpyridine; acrylic acid or methacrylic acid derivatives such as acrylonitrile, methacrylonitrile and acrylamide.

Polymerizable vinyl monomers forming a resin usable in the toner relating to the present invention can also employ one containing an ionic dissociative group such as a carboxyl group, a sulfonic acid group or a phosphoric acid group.

Examples of such one containing a carboxyl group include acrylic acid, methacrylic acid, maleic acid, itaconic acid, cinnamic acid, fumaric acid, maleic acid monoalkyl ester and itaconic acid monoalkyl ester. Examples of such one containing a sulfonic acid group include styrene sulfonic acid, allylsulfosuccinic acid, and 2-acrylamido-2-methylpropane sulfonic acid. Examples of such one containing a phosphoric acid group include acidophosphooxyethyl methacrylate.

A resin of a crosslinking structure can also prepare by using poly-functional vinyl compounds. Examples thereof are as below:

ethylene glycol dimethacrylate, ethylene glycol diacrylate, diethylene glycol dimethacrylate, diethylene glycol diacrylate, triethylene glycol dimethacrylate, triethylene glycol diacrylate, neopentylene glycol dimethacrylate, and neopentylene glycol diacrylate.

Colorants usable in the toner relating to the present invention include those known in the art and specific examples thereof are as follows:

Examples of black colorants include carbon black such as Furnace Black, Channel Black, Acetylene Black, Thermal Black and Lamp Black and magnetic powder such as magnetite and ferrite.

Magenta and red colorants include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48, C.I. Pigment Red 53:1, C.I. Pigment Red 57:1, C.I. Pigment Red 60, C.I. Pigment Red 63, C.I. Pigment Red 64, C.I. Pigment Red 68, C.I. Pigment Red 81, C.I. Pigment Red 83, C.I. Pigment Red 87, C.I. Pigment Red 88, C.I. Pigment Red 89, C.I. Pigment Red 90, C.I. Pigment Red 112, C.I. Pigment Red 114, C.I. Pigment Red 122, C.I. Pigment Red 123, C.I. Pigment Red 139, C.I. Pigment Red 144, C.I. Pigment Red 149, C.I. Pigment Red 150, C.I. Pigment Red 163, C.I. Pigment Red 166, C.I. Pigment Red 170 C.I. Pigment Red 177, C.I. Pigment Red 178, C.I. Pigment Red 184, C.I. Pigment Red 202, C.I. Pigment Red 206, C.I. Pigment Red 207, C.I. Pigment Red 209, C.I. Pigment Red 222 C.I. Pigment Red 238 and C.I. Pigment Red 169.

Orange or yellow colorants include C.I. Pigment Orange 31, C.I. Pigment Orange 43, C.I. Pigment Yellow 12, C.I. Pigment Yellow 14, C.I. Pigment Yellow 15, C.I. Pigment Yellow 17, C.I. Pigment Yellow 74, C.I. Pigment Yellow 83 C.I. Pigment Yellow 93, C.I. Pigment Yellow 94, C.I., Pigment Yellow 138, C.I. Pigment Yellow 155, C.I. Pigment Yellow 162, C.I. Pigment Yellow 180 and C.I. Pigment Yellow 185.

Green or cyan colorants include C.I. Pigment Blue 2, C.I. Pigment Blue 3, C.I. Pigment Blue 15, C.I. Pigment Blue 15:2, C.I. Pigment Blue 15:3, C.I. Pigment Blue 15:4, C.I. Pigment Blue 16, C.I. Pigment Blue 17, C.I. Pigment Blue 60, C.I. Pigment Blue 62, C.I. Pigment Blue 66 and C.I. Pigment Green 7.

Dyes include C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Yellow 2, C.I. Solvent Yellow 6, C.I. Solvent Yellow 14, C.I. Solvent Yellow 15, C.I. Solvent Yellow 16, C.I. Solvent Yellow 19, C.I. Solvent Yellow 21, C.I. Solvent Yellow 33, C.I. Solvent Yellow 44, C.I. Solvent Yellow 56, C.I. Solvent Yellow 61, C.I. Solvent Yellow 77, C.I. Solvent Yellow 79, C.I. Solvent Yellow 80, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93 and C.I. Solvent Blue 95.

The foregoing colorants may be used alone or in combination. The colorant content is preferably from 1% to 30% by mass, and more preferably 2% to 20% by mass of the whole of a toner. A number average primary particle size, depending of its kind, is approximately from 10 to 200 nm.

A colorant is added, for example, at the time when resin particles are coagulated by a coagulant to color a polymer. The colorant particle surface may be treated by a coupling agent or the like.

There will be described wax usable for the toner relating to the invention. Waxes usable in the toner of the present invention are those known in the art. Examples thereof include: (1) polyolefin wax such as polyethylene wax and polypropylene wax; (2) long chain hydrocarbon wax such as paraffin wax and sasol wax; (3) dialkylketone type wax such as distearylketone; (4) ester type wax such as carnauba wax, montan wax, trimethylolpropane tribehenate, pentaerythritol tetramyristate, pentaerythritol tetrabehenate, pentaerythritol diacetate dibehenate, glycerin tribehenate, 1,18-octadecanediol distearate, trimellitic acid tristearate, and distearyl meleate; (5) amide type wax such as ethylenediamine dibehenylamide and trimellitic acid tristearylamide.

The melting point of a wax usable in the invention is preferably 40 to 160° C., more preferably 50 to 120° C., and still more preferably 60 to 90° C. A melting point falling within the foregoing range ensures heat stability of toners and can achieve stable toner image formation without causing cold offsetting even when fixed at a relatively low temperature. The wax content of the toner is preferably in the range of 1% to 30% by mass, and more preferably 5% to 20%.

Methods of adding a wax to a toner include, for example, dissolution in a solution of a polymerizable monomer to form a binder resin. Alternatively, a wax is heated at a higher temperature than its melting temperature, added to an aqueous surfactant solution heated at the same temperature and dispersed to form fine particles by a dispersing method such as ultrasonic or high speed stirring. The thus formed fine particles are coagulated together with resin particles or colorant particles and coagulated particles are fused, which are added to a toner.

There may be incorporated, in the process of preparing the toner of the invention, inorganic organic microparticles having a number-average primary particle size of 4 to 800 nm as an external additive to prepare the toner.

Incorporation of an external additive results in improved fluidity or electrostatic property or achieves enhanced cleaning ability. The kind of external additives is not specifically limited and examples thereof include inorganic microparticles, organic microparticles and a sliding agent, as described below.

There are usable commonly known inorganic microparticles and preferred examples thereof include silica, titania, alumina and strontium titanate microparticles. There may optionally be used inorganic microparticles which have been subjected to a hydrophobilization treatment.

Specific examples of silica microparticles include R-976, R-974, R-972, R-812 and R-809 which are commercially available from Nippon Aerosil Co., Ltd.; HVK-2150 and H-200 which are commercially available from Hoechst Co.; TS-720, TS-530, TS-610, H-5 and MS-5 which is commercially available from Cabot Co.

Examples of titania microparticles include T-805 and T-604 which are commercially available from Nippon Aerosil Co. Ltd.; MT-100S, MT-100B, MT-500BS, MT-600, MT-600SJA-1 which are commercially available from Teika Co.; TA-300SI, TA-500, TAF-130, TAF-510 and TAP-510T which as commercially available from Fuji Titan Co., Ltd.; IT-S, IT-OB and IT-OC which as commercially available from Idemitsu Kosan Co., Ltd.

Examples of alumina microparticles include RFY-C and C-604 which are commercially available from Nippon Aerosil Co., Ltd.; and TTO-55, commercially available from Ishihara Sangyo Co., Ltd.

Spherical organic microparticles having a number-average primary particle size of 10 to 2000 nm are usable as organic microparticles. Specifically, there is usable styrene or methyl methacrylate homopolymer or their copolymers.

There are also usable lubricants, such as long chain fatty acid metal salts to achieve enhanced cleaning ability or transferability. Examples of a long chain fatty acid metal salt include zinc, copper, magnesium, and calcium stearates; zinc, manganese, iron, copper and magnesium oleates; zinc, copper, magnesium, and calcium palmitates; zinc and calcium linolates; zinc and calcium ricinolates.

Such an external additive or lubricant is incorporated preferably in an amount of 0.1 to 10.0% by weight of the total toner.

A toner relating to the invention is used a two-component developer comprised of a carrier and a toner, or a single-component developer comprised of a toner alone.

The use of the toner of the invention as a two-component developer enables full-color printing by using a tandem system image forming apparatus, as described later. Magnetic particles used as a carrier of a two-component developer can use commonly known materials, e.g., metals such as iron, ferrite and magnetite and alloys of the foregoing metals and metals such as aluminum or lead. Of these, ferrite particles are preferred. A volume-based average particle size of a carrier is preferably from 15 to 100 μm, and more preferably 25 to 80 μm.

When used as a nonmagnetic single-component developer without a carrier to perform image formation, a toner is charged with being rubbed or pressed onto a charging member or the developing roller surface. Image formation in a nonmagnetic single-component development system can simplify the structure of a developing device, leading to a merit of compactification of the whole image forming apparatus. Therefore, the use of the toner of the invention as a single-component developer can achieve full-color printing in a compact printer, making it feasible to prepare full-color prints of superior color reproduction even in a space-limited working environment.

In the following, there will be described an image forming method enabling to use the toner relating to the present invention. The image forming method relating to the invention employs a toner comprising a binder resin and a colorant, in which the binder resin contains a polyester ionomer resin that has been reacted with a polyvalent isocyanate compound and forms a toner image on a transfer paper to make a print via the following steps:

(1) a latent image forming step of forming a latent image on the surface of an electrophotographic photoreceptor,

(2) development step of developing the electrophotographic latent image formed on the surface of an electrophotographic photoreceptor to form a toner image,

(3) transfer step of transferring the toner image onto the surface of a transfer material, and

(4) fixing step of thermally fixing the toner image transferred onto the transfer material.

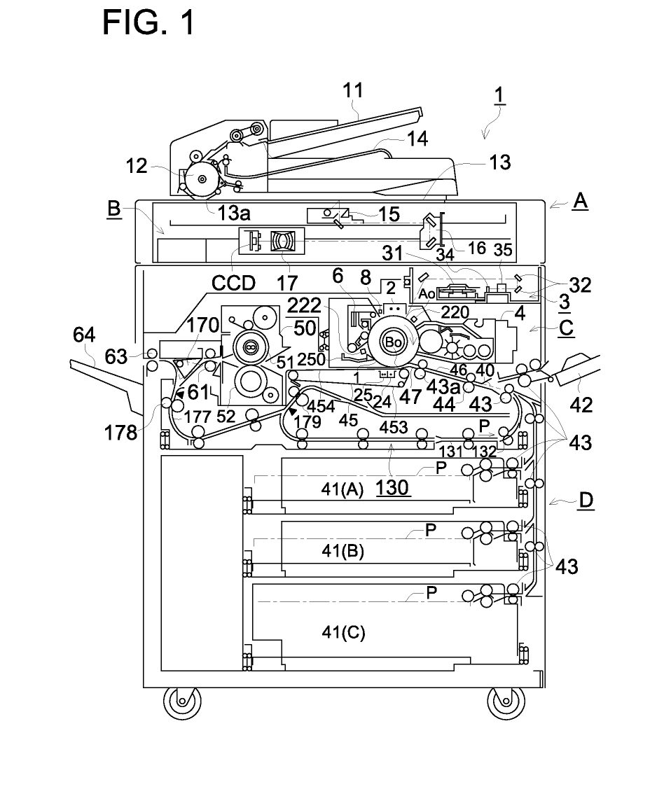

FIG. 1 illustrates an example of an image forming apparatus to perform a monochromatic type image formation by using a toner relating to the present invention.

An image forming apparatus 1, as illustrated in FIG. 1, is a digital type image forming apparatus, which comprises an image reading section A, an image processing section B, an image forming section C and a transfer paper conveyance section D as a means for conveying transfer paper.

An automatic manuscript feeder to automatically convey a manuscript is provided above the image reading section. A manuscript placed on a manuscript-setting table 11 is conveyed sheet by sheet by a manuscript-conveying roller 12 and read at a reading position 13a to read images. A manuscript having finished manuscript reading is discharged onto a manuscript discharge tray 14 by the manuscript-conveying roller 12.

On the other hand, the image of a manuscript placed on a platen glass 13 is read by a reading action, at a rate of v, of a first mirror unit 15 constituted of a lighting lamp and a first mirror, followed by conveyance at a rate of v/2 toward a second mirror unit 16 constituted of a second mirror and a third mirror which are disposed in a V-form.

The thus read image is formed through a projection lens 17 onto the acceptance surface of an image sensor CCD as a line sensor. Aligned optical images formed on the image sensor CCD are sequentially photo-electrically converted to electric signals (luminance signals), then subjected A/D conversion and further subjected to treatments such as density conversion and a filtering treatment in the image processing section B, thereafter, the image data is temporarily stored in memory.

In the image forming section C is provided a drum-form photoreceptor 1 as an image bearing body and in its surrounding, a charger 2, a potential sensor 220 to detect the surface potential of the charged photoreceptor, a developing device 4, a transfer means 5, a cleaning device 6 (cleaning step) for the photoreceptor 21 and a pre-charge lamp (PCL) 8 as a photo-neutralizer (photo-neutralizing step) are disposed in the order to carry out the respective operations. A reflection density detector 222 to measure the reflection density of a patch image developed on the photoreceptor 1 is provided downstream from the developing means 4. The photoreceptor 1 is rotatably driven clockwise, as indicated.

After having been uniformly charged by the charger 2, the photoreceptor 1 is imagewise exposed through an exposure optical system as an image exposure means 3, based on image signals called up from the memory of the image processing section B. The image exposure means 3 exposes the photoreceptor at the position of Ao to form an electrostatic latent image on the surface of the photoreceptor 1.

The electrostatic latent image on the photoreceptor 1 is developed by the developing means 4 to form a toner image on the photoreceptor 1.

In the transfer paper conveyance section D, paper supplying units 41(A), 41(B) and 41(C) as a transfer paper housing means for housing transfer paper P differing in size are provided below the image forming unit and a paper hand-feeding unit 42 is laterally provided, and transfer paper P chosen from either one of them is fed by a guide roller 43 along a conveyance route 40. After the fed paper P is temporarily stopped by paired paper feeding resist rollers 44 to make correction of tilt and bias of the transfer paper P, paper feeding is again started and the paper is guided to the conveyance route 40, a transfer pre-roller 43a, a paper feeding route 46 and entrance guide plate 47. A toner image on the photoreceptor 1 is transferred onto the transfer paper P at the position of Bo by a transfer pole 24 and a separation pole 25, while being conveyed with being put on a transfer conveyance belt 454 of a transfer conveyance belt device 45. The transfer paper P is separated from the surface of the photoreceptor 21 and conveyed to a fixing device 50 by the transfer conveyance belt 5.

The fixing device 50 has a fixing roller 51 and a pressure roller 52 and allows the transfer paper P to pass between the fixing roller 51 and the pressure roller 52 to fix the toner by heating and pressure. The transfer paper P which has completed fixing of the toner image is discharged onto a paper discharge tray 64.

Image formation on one side of transfer paper is described above and in the case of two-sided copying, a paper discharge switching member 170 is switched over, and a transfer paper guide section 177 is opened and the transfer paper P is conveyed in the direction of the dashed arrow. Further, the transfer paper P is conveyed downward by a conveyance mechanism 178 and switched back in a transfer paper reverse section 179, and the rear end of the transfer paper P becomes the top portion and is conveyed to the inside of a paper feed unit 130 for two-sided copying. Further, the transfer paper P is conveyed downward by a conveyance mechanism 178 and switched back in a transfer paper reverse section 179, and the rear end of the transfer paper P becomes the top portion and is conveyed to the inside of a paper feed unit 130 for two-sided copying. The transfer paper P is moved along a conveyance guide 131 in the paper feeding direction, transfer paper P is again fed by a paper feed roller 132 and guided into the transfer route 40. According to the foregoing procedure, a toner image can be formed on the back surface of the transfer paper P.

In an image forming apparatus relating to the invention, constituent elements such as a photoreceptor, a developing device and a cleaning device may be integrated as a process cartridge and this unit may be freely detachable. At least one of an electrostatic charger, an image exposure device, a transfer or separation device and a cleaning device is integrated with a photoreceptor to form a process cartridge as a single detachable unit from the apparatus body and may be detachable by using a guide means such as rails in the apparatus body.

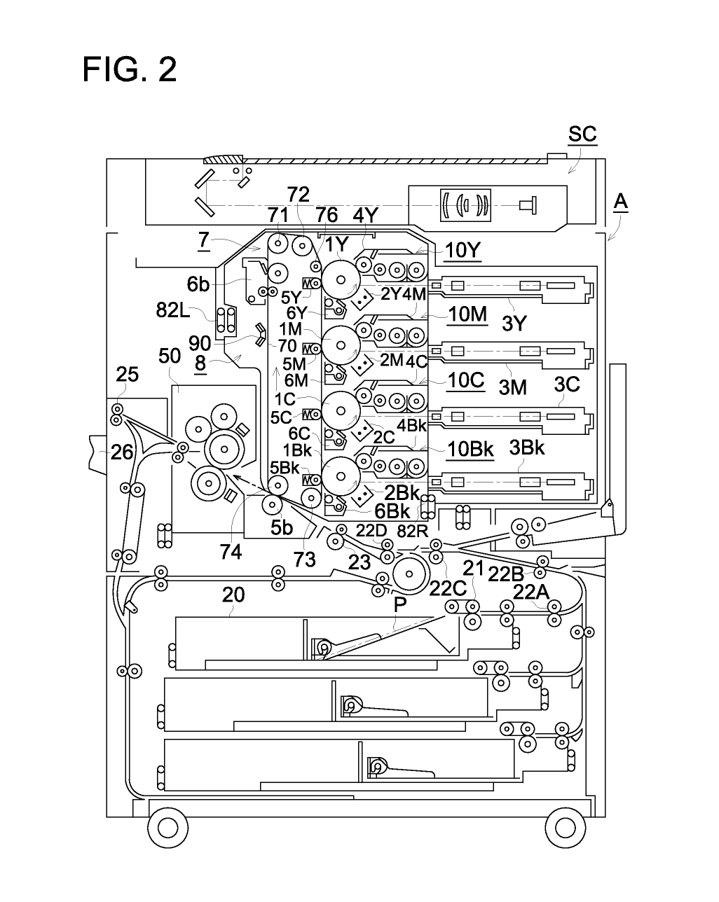

FIG. 2 shows a schematic view of a color image forming apparatus showing one of the embodiments of the invention.

In FIG. 2, 1Y, 1M, 1C and 1K are each a photoreceptor; 4Y, 4M, 4C and 4K are each a developing device; 5Y, 5M, 5C and 5K are each a primary transfer roll as a primary transfer means; 5A is a secondary transfer roll as a secondary transfer means; 6Y, 6M, 6C and 6K are each a cleaning device; 7 is an intermediate transfer unit, 50 is a heat roll type fixing device, and 70 is an intermediate transfer body unit, 50 is a heat roll type fixing device.

This image forming apparatus is called a tandem color image forming apparatus, which is, as a main constitution, comprised of plural image forming sections 10Y, 10M, 10C and 10Bk; an intermediate transfer material unit 7 of an endless belt form, a paper feeding and conveying means 21 to convey a recording member P and a heat-roll type fixing device 50 as a fixing means. Original image reading device SC is disposed in the upper section of an image fanning apparatus body A.

As one of different color toner images of the respective photoreceptors, image forming section 10Y to form a yellow image comprises a drum-form photoreceptor 1Y as the first photoreceptor; an electrostatic-charging means 2Y, an exposure means 3Y, a developing means 4Y, a primary transfer roller 5Y as a primary transfer means; and a cleaning means 6Y, which are disposed around the photoreceptor 1Y.

As another one of different color toner images of the respective photoreceptors, image forming section 10M to form a magenta image comprises a drum-form photoreceptor 1M as the first photoreceptor; an electrostatic-charging means 2M, an exposure means 3M, a developing means 4M, a primary transfer roller 5M as a primary transfer means; and a cleaning means 6M, which are disposed around the photoreceptor 1M. Further, as one of different color toner images of the respective photoreceptors, image forming section 10C to form a cyan image comprises a drum-form photoreceptor 1C as the first photoreceptor; an electrostatic-charging means 2C, an exposure means 3C, a developing means 4C, a primary transfer roller 5C as a primary transfer means; and a cleaning means 6C, which are disposed around the photoreceptor 1C. Furthermore, as one of different color toner images of the respective photoreceptors, image forming section 10K to form a cyan image comprises a drum-form photoreceptor 1K as the first photoreceptor; an electrostatic-charging means 2K, an exposure means 3K, a developing means 4K, a primary transfer roller 5K as a primary transfer means; and a cleaning means 6K, which are disposed around the photoreceptor 1K.

Intermediate transfer unit 7 of an endless belt form is turned by plural rollers and has intermediate transfer material 70 as the second image carrier of an endless belt form, while being pivotably supported.

The individual color images formed in image forming sections 10Y, 10M, 10C and 10Bk are successively transferred onto the moving intermediate transfer material (70) of an endless belt form by primary transfer rollers 5Y, 5M, 5C and 5Bk, respectively, to form a composite color image. Recording member P of paper or the like, as a final transfer material housed in a paper feed cassette 20, is fed by paper feed and a conveyance means 21 and conveyed to a secondary transfer roller 5b through plural intermediate rollers 22A, 22B, 22C and 22D and a resist roller 23, and color images are secondarily transferred together on the recording member P. The color image-transferred recording member (P) is fixed by a heat-roll type fixing device 24, nipped by a paper discharge roller 25 and put onto a paper discharge tray outside a machine.

After a color image is transferred onto the recording member P by a secondary transfer roller 5b as a secondary transfer means, an intermediate transfer material 70 of an endless belt form which separated the recording material P removes any residual toner by cleaning means 6b.

During the image forming process, the primary transfer roller 5Bk is always in contact with the photoreceptor 1Bk. Other primary transfer rollers 5Y, 5M and 5C are each in contact with the respectively corresponding photoreceptors 1Y, 1M and 1C only when forming a color image.

The secondary transfer roller 5A is in contact with the intermediate transfer material 70 of an endless belt form only when the recording member P passes through to perform secondary transfer.

A housing 8, which can be pulled out from the apparatus body A through supporting rails 82L and 82R, is comprised of image forming sections 10Y, 10M, 10C and 10Bk and the endless belt intermediate transfer unit 7.

Image forming sections 10Y, 10M, 10C and 10Bk are aligned vertically. The endless belt intermediate transfer material unit 7 is disposed on the left side of photoreceptors 1Y, 1M, 1C and 1Bk, as indicated in FIG. 2. The intermediate transfer material unit 7 comprises the endless belt intermediate transfer material 70 which can be turned via rollers 71, 72, 73 and 74, primary transfer rollers 5Y, 5M, 5C and 5Bk and cleaning means 6b.

Thus, toner images are formed on the photoreceptors 1Y, 1M, 1C and 1K via charging, exposure and development, toner images of the respective colors are superimposed on the endless belt intermediate transfer material 70, transferred together to the recording member P and fixed by applying pressure with heating in the fixing device 50. After having transferred the toner image onto the recording member P, the photoreceptor 1Y, 1M, 1C and 1K are each cleaned in a cleaning device to remove a remained toner and enter the next cycle of charging, exposure, and development to perform image formation.

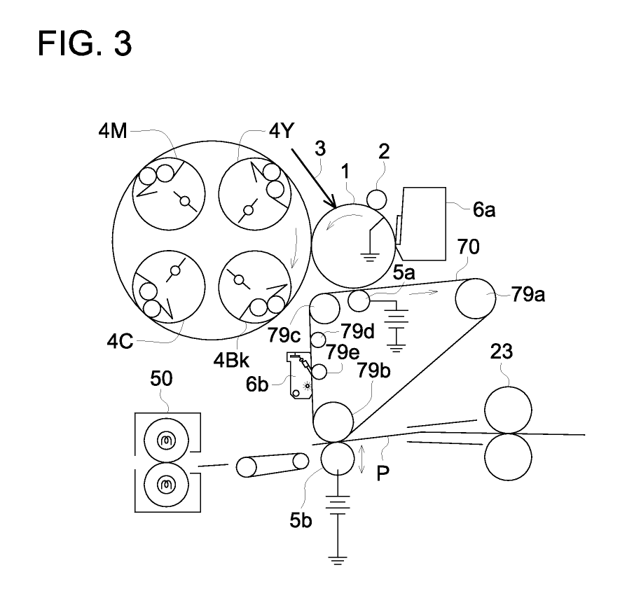

FIG. 3 also shows a schematic sectional view of a color image forming apparatus differing from the image forming apparatus shown in FIG. 2. The image forming apparatus of FIG. 3 comprises, around an organic photoreceptor, an electrostatic-charging means, an exposure means, plural developing means, a transfer means, a cleaning means and an intermediate transfer means. The intermediate transfer material 70 of an endless belt faun employs an elastomer of moderate resistance.

The numeral 1 designates a rotary drum type photoreceptor, which is repeatedly used as an image forming body, is rotatably driven anticlockwise, as indicated by the arrow, at a moderate circumferential speed. The photoreceptor 1 is uniformly subjected to an electrostatic-charging treatment at a prescribed polarity and potential by a charging means 2, while being rotated. Subsequently, the photoreceptor 1 is subjected to image exposure via an image exposure means 3 to form an electrostatic latent image corresponding to a yellow (Y) component image (color data) of the objective color image.

Subsequently, the electrostatic latent image is developed by a yellow toner of a first color in a yellow (Y) developing means 4Y: developing step (the yellow developing device). At that time, the individual developing devices of the second to fourth developing means 4M, 4C and 4Bk (magenta developing device, cyan developing device, black developing device) are in operation-off and do not act onto the photoreceptor 1 and the yellow toner image of the first color is not affected by the second to fourth developing devices.

The intermediate transfer material 70 is rotatably driven clockwise at the same circumferential speed as the photoreceptor 1, while being tightly tensioned onto rollers 79a, 79b, 79c, 79d and 79e.

The yellow toner image formed and borne on the photoreceptor 1 is successively transferred (primary-transferred) onto the outer circumferential surface of the intermediate transfer material 70 by an electric field formed by a primary transfer bias applied from a primary transfer roller 5a to the intermediate transfer material 70 in the course of being passed through the nip between the photoreceptor 1 and the intermediate transfer material 70.

The surface of the photoreceptor 1 which has completed transfer of the yellow toner image of the first color is cleaned by a cleaning device 6a.

In the following, a magenta toner image of the second color, a cyan toner image of the third color and a black toner image of the fourth color are successively transferred onto the intermediate transfer material 70 and superimposed to form superimposed color toner images corresponding to the intended color image.

A secondary transfer roller 5b, which is allowed to bear parallel to a secondary transfer opposed roller 79b, is disposed below the lower surface of the intermediate transfer material 70, while being kept in the state of being separable.

The primary transfer bias for transfer of the first to fourth successive color toner images from the photoreceptor 1 onto the intermediate transfer material 70 is at the reverse polarity of the toner and applied from a bias power source. The applied voltage is, for example, in the range of +100 V to +2 kV.

In the primary transfer step of the first through third toner images from the photoreceptor 1 to the intermediate transfer material 70, the secondary transfer roller 5b and the cleaning means 6b for the intermediate transfer material are each separable from the intermediate transfer material 70.

The superimposed color toner image which was transferred onto the intermediate transfer material 70 is transferred to a transfer material P as the second image bearing body in the following manner. Concurrently when the secondary transfer roller 5b is brought into contact with the belt of the intermediate transfer material 70, the transfer material P is fed at a prescribed timing from paired paper-feeding resist rollers 23, through a transfer paper guide, to the nip in contact with the belt of the intermediate transfer material 70 and the secondary transfer roller 5b. A secondary transfer bias is applied to the second transfer roller 5b from a bias power source. This secondary bias transfers (secondary-transfers) the superimposed color toner image from the intermediate transfer material 70 to the transfer material P as a secondary transfer material. The transfer material P having the transferred toner image is introduced to a fixing means 24 and is subjected to heat-fixing.

### Examples

The present invention will be further described with reference to examples, but the embodiments of the invention are by no means limited to these. In the following examples, “part(s)” represents part(s) by mass unless otherwise noted.

### Preparation of Vinyl Resin Particle Dispersion 1:

First, there was prepared a solution of a monomer mixture comprised of the following compounds.

| | |
|---|---|
| Styrene | 201 parts by mass |
| Butyl acrylate | 117 parts by mass |
| Methacrylic acid | 18.3 parts by mass |

Further, the foregoing monomer mixture solution was heated to 80° C. with stirring, the following compound was gradually added thereto and dissolved to prepare a solution of a monomer mixture.

| | |
|---|---|
| Behenyl behenate | 172 parts by mass |

Subsequently, the mixed solution was added to a solution of 11.3 parts by mass of anionic surfactant, EMAL E27C (produced by KAO Co., Ltd.) dissolved in 1182 parts by mass of pure water, maintained at 80° C. and then was subjected to high-speed stirring to prepare a monomer dispersion.

Then, into a reactor equipped with a stirrer, a temperature sensor, a condenser and a nitrogen gas introducing device was added 867.5 of deionized water and the internal temperature was raised to 80° C., while stirring under a nitrogen gas stream.

Into the reactor was added the foregoing monomer solution and further thereto was added an aqueous polymerization initiator solution of 8.55 g of potassium persulfate dissolved in 162.5 g of pure water.

After addition of the aqueous polymerization initiator solution, the following compound was added thereto over 35 minutes and polymerization reaction was performed at 80° C. for 2 hours.

n-Octylmercaptan 5.2 parts by mass

After performing the polymerization reaction, an aqueous polymerization initiator solution of 9.96 parts by mass of potassium persulfate dissolved in 189.3 parts by mass of deionized water was added to the reactor and a monomer mixed solution comprised of compounds described below was add dropwise over 1 hour.

| | |
|---|---|
| Styrene | 366.1 parts by mass |
| Butyl acrylate | 179.1 parts by mass |
| n-Octylmercaptan | 7.2 parts by mass |

After adding the foregoing monomer mixed solution, polymerization reaction was performed for 2 hours and thereafter, the reaction mixture was cooled to room temperature. Vinyl resin particle dispersion 1 was thus prepared.

### Preparation of Shell Resin Particle Dispersion:

Into a reactor equipped with a stirrer, a temperature sensor, a condenser and a nitrogen gas introducing device were added 2948 parts by mass of deionized water and 2.3 parts by mass of anionic surfactant, EMAL 2FG (produced by KAO Co., Ltd.) to prepare an aqueous surfactant solution.

Subsequently, there were prepared a monomer mixed solution composed of compounds described below and a polymerization initiator solution of 10.2 parts by mass of potassium persulfate (KPS) dissolved in 218 parts by mass of deionized water.

| | |
|---|---|
| Styrene | 532 parts by mass |
| n-Butyl acrylate | 184 parts by mass |
| Methacrylic acid | 96 parts by mass |
| n-Octylmercaptane | 22.1 parts by mass |

After adding the polymerization initiator solution to the surfactant solution, the foregoing monomer mixed solution was added over 3 hours. After performing polymerization over 1 hour, the reaction mixture was cooled to room temperature to prepare a shell resin particle dispersion. The weight average molecular weight of shell resin particles was 13,200 and the mass average particle diameter was 82 nm.

### Preparation of Cyan Colorant Particle Dispersion:

In 1600 parts by mass of pure water was dissolved 11.5 parts by mass of sodium n-dodecyl sulfate to prepare an aqueous surfactant solution. To the aqueous surfactant solution was gradually added 25 parts by mass of C.I. Pigment Blue 15:3 and stirred by using CLEARMIX W motion CLM-0.8 (made by M-Technique Co., Ltd.) to prepare a dispersion of cyan colorant particles having a volume-based median diameter of 153 nm.

### Preparation of Magenta Colorant Particle Dispersion:

A dispersion of magenta colorant particles having a volume-based median diameter of 183 nm was prepared in the same manner as the foregoing cyan colorant particle dispersion, except that C.I. Pigment Blue 15:3 was replaced by C.I. Pigment Red 122.

### Preparation of Yellow Colorant Particle Dispersion:

A dispersion of yellow colorant particles having a volume-based median diameter of 177 nm was prepared in the same manner as the foregoing cyan colorant particle dispersion, except that C.I. Pigment Blue 15:3 was replaced by C.I. Pigment Yellow 74.

### Preparation of Black Colorant Particle Dispersion:

A dispersion of black colorant particles having a volume-based median diameter of 167 nm was prepared in the same manner as the foregoing cyan colorant particle dispersion, except that C.I. Pigment Blue 15:3 was replaced by carbon black, Mogul L (made by Cabot Co.).

### Preparation of Polyester Ionomer Resin Particle Dispersion 1:

Into a reaction vessel equipped with a stirrer, a condenser and a nitrogen gas introducing device were added compounds below.

| | |
|---|---|
| Bisphenol A with 2 mol ethylene oxide adduct | 229 parts by mass |
| Bisphenol A with 2 mol propylene oxide adduct | 529 parts by mass |
| Terephthalic acid | 208 parts by mass |
| Adipic acid | 46 parts by mass |
| Dibutyl tin oxide | 2 parts by mass |

After the foregoing compounds were reacted at 230° C. under ordinary pressure for 7 hours, the pressure inside the reaction vessel was reduced to 1.7 kPa (approximately 12.5 mmHg) and the reaction continued for 5 hours.

Thereafter, 44 parts by mass of trimellitic acid anhydride was added to the reaction vessel and reacted at 180° C. under ordinary pressure for 3 hours to obtain a polyester. The obtained polyester exhibited a weight average molecular weight of 6700, a number average molecular weight of 2300, a glass transition temperature of 43° C. and an acid value of 25 mgKOH/g.

Subsequently, 10 parts by mass of sodium dodecylsulfate and 6.25 parts by mass of magnesium hydroxide were added to 990 parts by mass of pure water to prepare an aqueous solution. In this aqueous solution was added a polyester solution of 250 parts by of the foregoing polyester dissolved in 300 parts by mass of ethyl acetate and dispersed by using CLEARMIX (made by M-Technique Co., Ltd.) at a stirring rate of 12000 rpm. Further, ethyl acetate was removed from the dispersion under reduced pressure to prepare “polyester ionomer resin particle dispersion 1”. The “polyester ionomer resin particle dispersion 1” had a solid content of 20.1% and a volume-based median diameter of 95 nm.

### Preparation of Polyester and Polyester Ionomer Resin Particle Dispersion 2:

Into a reaction vessel equipped with a stirrer, a condenser and a nitrogen gas introducing device were added compounds below.

| | |
|---|---|
| Bisphenol A with 2 mol ethylene oxide adduct | 229 parts by mass |
| Bisphenol A with 2 mol propylene oxide adduct | 529 parts by mass |
| Terephthalic acid | 208 parts by mass |
| Adipic acid | 46 parts by mass |
| Dibutyl tin oxide | 2 parts by mass |

After the foregoing compounds were reacted at 230° C. under ordinary pressure for 7 hours, the pressure inside the reaction vessel was reduced to 1.7 kPa (approximately 12.5 mmHg) and the reaction continued for 5 hours.

Thereafter, 44 parts by mass of trimellitic acid anhydride was added to the reaction vessel and reacted at 180° C. under ordinary pressure for 3 hours to obtain a polyester. The obtained polyester exhibited a weight average molecular weight of 6700, a number average molecular weight of 2300, a glass transition temperature of 43° C. and an acid value of 25 mgKOH/g.

Subsequently, 10 parts by mass of sodium dodecylsulfate and 6.25 parts by mass of magnesium hydroxide were added to 990 parts by mass of pure water to prepare an aqueous solution. In this aqueous solution was added a polyester solution of 250 parts by of the foregoing polyester dissolved in 300 parts by mass of ethyl acetate and dispersed by using CLEARMIX (made by M-Technique Co., Ltd.) at a stirring rate of 12000 rpm. Further, after ethyl acetate was removed from the dispersion under reduced pressure, 5 parts by mass of hexamethylene diisocyanates was added and reacted at 80° C. for 3 hours to prepare “polyester ionomer resin particle dispersion 2” having an extended chain structure. The “polyester ionomer resin particle dispersion 2” had a solid content of 20.0% and a volume-based median diameter of 90 nm.

### Preparation of Colored Particle 1:

The following mixture was placed into a reaction vessel equipped with a stirrer, a condenser and a nitrogen gas introducing device.

| | |
|---|---|
| Vinyl resin particle dispersion 1 | 357 parts by mass (solids) |
| Polyester ionomer resin particle (Finetex | 63 parts by mass (solids) |
| ES-675, Dainippon Ink Kagaku Kogyo) | |
| Deionized water | 900 parts by mass |
| Cyan colorant particle dispersion | 200 parts by mass (solids) |

The temperature inside the reaction vessel was maintained at 30° C. and the pH was adjusted to 10 by adding an aqueous 5 mol/l sodium hydroxide solution.

Further thereto, an aqueous solution of 2 parts by mass of magnesium chloride hexahydride, dissolved in 1000 parts by mass of deionized water was added dropwise over 10 minutes, while stirring. After completion of addition, the temperature inside the reaction vessel was raised to 75° C. to initiate particle formation and stirring with heating continued until the volume-based median diameter reached 6.5 μm by using Coulter Counter TA-II (Beckman Coulter Co.).

When the volume-based median diameter reached 6.5 μm, 210 parts by mass (solids) of the shell resin particle dispersion was added and stirred over 1 hour to allow shell resin particles to be fused on the core particle surface. After stirring continued further for 30 minutes and the shell layer was completely formed, an aqueous sodium chloride solution of 40 g of sodium chloride dissolved in 500 parts by mass of deionized water was added thereto and after the internal temperature was raised to 78° C. and stirred for 1 hour, the internal temperature was lowered to room temperature (25° C.).

Thereafter, the volume-based median diameter and the average circularity of colored particles were measured by using Coulter Counter TA-II (Beckman Coulter Co.) and FPIA 2100 (Sysmex Co.) and proved to be 6.48 μm and 0.965, respectively. Further, the thus formed colored particles were repeatedly washed with deionized water and dried by heated air, whereby colored particle 3 was obtained.

### Preparation of Colored Particle 3:

Colored particle 3 exhibiting a volume-based median diameter of 6.43 μm and an average circularity of 0.958 was prepared in the same manner as the colored particle 1, except that the polyester ionomer resin particle was changed to Finetex ES-850 (Dainippon Ink Kagaku Kogyo).

### Preparation of Colored Particle 4:

Colored particle 4 exhibiting a volume-based median diameter of 6.62 μm and an average circularity of 0.968 was prepared in the same manner as the colored particle 1, except that the polyester ionomer resin particle was changed to Finetex ES-801 (Dainippon Ink Kagaku Kogyo).

### Preparation of Colored Particle 9:

Colored particle 9 exhibiting a volume-based median diameter of 6.55 μm and an average circularity of 0.965 was prepared in the same manner as the colored particle 1, except that the polyester ionomer resin particle was changed to the above-described polyester ionomer resin particle dispersion 1.

### Preparation of Colored Particle 10:

Colored particle 10 exhibiting a volume-based median diameter of 6.45 μm and an average circularity of 0.970 was prepared in the same manner as the colored particle 1, except that the polyester ionomer resin particle was changed to the above-described polyester ionomer resin particle dispersion 2.

### Preparation of Colored Particle 11:

Colored particle 11 exhibiting a volume-based median diameter of 6.38 μm and an average circularity of 0.975 was prepared in the same manner as the colored particle 1, except that after adding an aqueous sodium chloride solution after completion of shell layer formation, hexamethylene diisocyanate was added in an amount of 5 parts by mass and the internal temperature was raised to 78° C. and stirring continued for 1 hour.

### Preparation of Colored Particle 12:

Colored particle 12 exhibiting a volume-based median diameter of 6.40 μm and an average circularity of 0.973 was prepared in the same manner as the colored particle 3, except that after adding an aqueous sodium chloride solution after completion of shell layer formation, hexamethylene diisocyanate was added in an amount of 5 parts by mass and the internal temperature was raised to 78° C. and stirring continued for 1 hour.

### Preparation of Colored Particle 13:

Colored particle 13 exhibiting a volume-based median diameter of 6.42 μm and an average circularity of 0.971 was prepared in the same manner as the colored particle 4, except that after adding an aqueous sodium chloride solution after completion of shell layer formation, hexamethylene diisocyanate was added in an amount of 5 parts by mass and the internal temperature was raised to 78° C. and stirring continued for 1 hour.

### Preparation of Colored Particle 14:

Colored particle 14 exhibiting a volume-based median diameter of 6.45 μm and an average circularity of 0.970 was prepared in the same manner as the colored particle 9, except that after adding an aqueous sodium chloride solution after completion of shell layer formation, hexamethylene diisocyanate was added in an amount of 5 parts by mass and the internal temperature was raised to 78° C. and stirring continued for 1 hour.

### Preparation of Comparative Colored Particle 1:

Comparative colored particle 1 exhibiting a volume-based median diameter of 6.53 μm and an average circularity of 0.950 was prepared in the same manner as the colored particle 1, except that the polyester ionomer resin particle was replaced by styrene-butyl acrylate-methacrylic acid copolymer resin particles (styrene:buthyl acrylate:methgacrylic acid=66.5:25:8.5 by mass) exhibiting a weight average molecular weight of 100,000 and a glass transition temperature of 50° C.

### Preparation of Comparative Colored Particle 2:

Comparative colored particle 2 exhibiting a volume-based median diameter of 6.72 μm and an average circularity of 0.949 was prepared in the same manner as the foregoing comparative colored particle 1, except that the styrene-butyl acrylate-methacrylic acid copolymer resin particles was changed to those exhibiting a weight average molecular weight of 10,000 (exhibiting the same ratio of styrene:butyl acrylate:methacrylic acid).

### Preparation of Toners 1, 3, 4, 9, 10-14 and Comparative Toners 1-2:

An external additive having the composition, as described below, was added to each of the foregoing colored particles 1, 3, 4, 9, 10-14 and comparative color particles 1 and 2 to perform an external additive treatment in a HENSCHEL mixer (made by Mitsui Miike Kogyo Co., Ltd.), whereby toners 1, 3, 4, 9, 10-14 and comparative toners 1 and 2 were obtained.

| | |
|---|---|
| Hydrophobic silica (number average primary | 1 part by mass |
| particle size: 12 nm, hydrophobicity degree: 68) | |
| Hydrophobic titanium oxide (number average primary | 1 part by mass |
| particle size; 20 nm hydrophobicity degree: 64) | |

After performing a mixing treatment by using a HENSCHEL mixer (made by Mitsui Miike Kogyo Co., Ltd.), coarse particles were removed by using a sieve with a sieve opening of 45 μm to prepare the foregoing toners.

### Preparation of Developers 1, 3, 4, 9 and 10-14 and Comparative Developers 1-2:

A carrier which was comprised of ferrite particles covered with a styrene-acryl resin and exhibited a number average particle size of 35 nm was added to each of the foregoing toners having been subjected to the external additive treatment to prepare Developers 1, 3, 4, 9 and 10-14 and Comparative Developers 1 and 2.

### Evaluation Experiment:

The foregoing developers 1, 3, 4, 9 and 10-14 and comparative developers 1 and 2 were each fed into an evaluation machine, which was installed with a modified fixing device of a commercially available digital printer, “bizhub Pro C500” (produced by Konica Minolta Business Technologies Inc.) and evaluated with respect to fixing offset and a fixing factor. The fixing device was modified so that the surface temperature of a heating roller for fixing was variable every 5° C. within the range of 105 to 210° C.

Evaluations by using developers 10-14 were denoted as Examples 10-14, evaluations by using comparative developers 1 and 2 were denoted as Comparative Examples 1 and 2, and evaluations by using developers 1, 3, 4 and 9 were denoted as Comparative Examples 3-6.

### Evaluation of Fixing Offset:

The surface temperature of a heating roller for fixing was varied at intervals 5° C. in the range of 120 to 210° C. At the respective surface temperatures, an A4-sized image, carrying a 5 mm wide, solid black belt-formed image which was arranged vertically to the conveyance direction was longitudinally conveyed to be fixed; then, an A4 image having a 5 mm wide, solid black belt-formed image and a 20 mm wide halftone image which were arranged vertically to the conveyance direction was laterally conveyed and fixed. The temperature at which image staining due to fixing offset occurred was determined on the high temperature side and on the low temperature side. Samples which caused no image staining at a temperature higher than 200° C. on the high temperature end and at a temperature lower than 150° C. on the low temperature end were evaluated to be acceptable in practice.

### Evaluation of Fixing Factor:

Using the foregoing a modified machine of “bizhub Pro C500”, solid images were prepared under an environment of 10° C. and 10% RH and the surface temperature of a heating roller for fixing was varied at intervals 5° C. in the range of 105 to 210° C. to evaluate fixed images. The thus fixed image was bent and thereafter, the image was repeatedly rubbed with cloth ten times by using a friction fastness tester and reflection densities before and after thereof were measured using RD-918 (Macbeth Co.) and a fixing factor was calculated in accordance with the following equation:

Fixing factor (%)=[(reflection density after being rubbed)/(reflection density before being rubbed)]×100

A fixing temperature at which the fixing factor calculated from the foregoing equation exceeds 80% as a level acceptable in practice was determined and evaluated. When a fixing factor of 80% or more was achieved at a temperature of not more than 150° C., it was considered to be acceptable in practice.

The initial image density was measured when the reflection density of paper was reduced to “0” and the relative density was adjusted to 1.40.

The results are shown in Table 1.

TABLE 1

| | | | | Temperature | Offset Resistance Evaluation | |
|---|---|---|---|---|---|---|
| | Developer | | | (° C.) of | High | Low |
| | (Toner) | Polyester Ionomer Resin | | Fixing Factor | Temperature | Temperature |
| | No. | Resin | IN Treatment* | of 80% or More | Side | Side |
| Example 10 | 10 | Polyester ionomer | Yes | 120 | Not less | 115 |
| | | resin particle 2 | | | than 210° C. | |
| Example 11 | 11 | Finetex ES-2200 | Yes | 120 | Not less | 115 |
| | | | | | than 210° C. | |
| Example 12 | 12 | Finetex ES-850 | Yes | 115 | Not less | 115 |
| | | | | | than 210° C. | |
| Example 13 | 13 | Finetex ES-801 | Yes | 115 | Not less | 115 |
| | | | | | than 210° C. | |
| Example 14 | 14 | Polyester ionomer | Yes | 120 | Not less | 115 |
| | | resin particle 1 | | | than 210° C. | |
| Comparison 1 | Comp. 1 | — | — | 185 | 195 | 170 |
| Comparison 2 | Comp. 2 | — | — | 175 | 180 | 160 |
| Comparison 3 | 1 | Finetex ES-2200 | — | 135 | Not less | 125 |
| | | | | | than 210° C. | |
| Comparison 4 | 3 | Finetex ES-850 | — | 145 | Not less | 140 |
| | | | | | than 210° C. | |
| Comparison 5 | 4 | Finetex ES-801 | — | 140 | Not less | 135 |
| | | | | | than 210° C. | |
| Comparison 6 | 9 | Polyester ionomer | — | 130 | Not less | 120 |
| | | resin particle 1 | | | than 210° C. | |

IN Treatment*: Treatment with a polyvalent isocyanate compound

As shown in Table 1, it was proved that Examples 10-14 in which a toner comprising a binder resin containing a polyester ionomer resin was used, were each superior in low temperature fixability and lower in offset occurrence temperature, and achieving both low temperature fixability and offset resistance. On the contrary, it was also proved that Comparison Examples 1 and 2 containing no polyester ionomer resin and Comparison Examples 3-6 containing no polyester ionomer resin having been reacted with a polyvalent isocyanate compound were each high in fixing temperature and also high in offset occurrence temperature and were inferior in offset resistance and low temperature fixability, compared to toners of the Examples.

### DESCRIPTION OF NUMERALS

1: Photoreceptor

2: Charger

3: Image exposure means

4: Developing device 4

5: Transfer means

6: Cleaning device

10: Image forming section

50: Fixing device

70: Intermediate transfer belt

What is claimed is:

1. A toner comprising a colorant and a binder resin, wherein the binder resin comprises a polyester ionomer resin which has been reacted with a polyvalent isocyanate compound.

2. A production method of a toner, the method comprising
allowing at least polyester ionomer resin particles and colorant particles to coagulate and fuse to produce particles.

3. The production method as claimed in claim 2, wherein the method comprises
reacting the polyester ionomer resin particles with a polyvalent isocyanate compound, and then
allowing the polyester ionomer resin particles and the colorant particles to coagulate and fuse to produce particles.

4. The production method as claimed in claim 2, wherein the method comprises
allowing the polyester ionomer resin particles and the colorant particles to coagulate and fuse to produce particles and then
reacting the produced particles with a polyvalent isocyanate compound.

5. A developer comprising a toner, as claimed in claim 1.

6. An image formation method comprising:
a latent image forming step of forming a latent image on the surface of an electrophotographic photoreceptor,
a developing step of developing the latent image formed on the photoreceptor surface with a developer, as claimed in claim 5 and carried by a developer carrier to form a toner image,
a transfer step of transferring the toner image onto the surface of a transfer material, and
a fixing step of heat-fixing the toner image transferred onto the transfer material surface.
